(19) United States
(12) Patent Application Publication
(10) Pub. No.: US 2020/0357301 A1
(43) Pub. Date: Nov. 12, 2020

(54) Interactive Learning Tool

(71) Applicant: Rose River Software, LLC, Scarsdale, NY (US)

(72) Inventors: Daniel Groner, Scarsdale, NY (US); Adam Groner, Palo Alto, CA (US)

(21) Appl. No.: 16/766,465

(22) PCT Filed: Dec. 7, 2018
(86) PCT No.: PCT/US18/64474

§ 371 Date: May 22, 2020

Related U.S. Application Data
(60) Provisional application No. 62/611,597, filed on Dec. 29, 2017.

(51) Int. Cl. G09B 19/00; G06F 9/451; G06F 8/34; G06F 8/33

(52) U.S. Cl. CPC G09B 19/0053; G06F 8/33; G06F 8/34; G06F 9/453

(57) ABSTRACT

A system and method are used for teaching a computer programming language, with the system having a visual module, a foundational module, a static module, and a dynamic module. The visual module includes example code of a particular program, a narrator, a console, a variable chart, a variable history, a flowchart, an animation control, a help window, and an optional example-specific control. The foundational module includes a shape module, a script engine, and a ScriptItem stored in a library. The shape module animates parts of the visual module. The static module provides all the static data for a given example while the dynamic module provides script items that correspond to the example code. In animation mode, the user sees an animated representation of the flow of the example code. In review mode, the user can click on the visual elements to see the relationship among the parts: code, flowchart, variables, inputs, and outputs.

### CROSS-REFERENCE TO RELATED APPLICATION

This application claims priority to U.S. Provisional Application No. 62/611,597, filed on Dec. 29, 2017, which is incorporated by reference in its entirety.

### FIELD

The present invention relates to interactive learning tools, more specifically to a computerized system for learning a computer programming language.

### BACKGROUND

Books provide the most comprehensive description of computer programming concepts and programming syntax. Commonly, a large number of small program examples are used to illustrate such computer programming concepts and programming syntax. However, the book descriptions of these examples are static text and so do not easily show the dynamic nature and relationships of a running program.

Lectures (in person, in classes, or online) provide verbal and written descriptions of programming concepts or syntax, and may be accompanied by a live demonstration program. A demonstration tool may include example code and input, outputs, and variables, but typically does not highlight the program components and their relationships. These connections are crucial to understanding programming.

Integrated Development Environments (IDEs) are professional tools used to develop software and can be used to create, run, and revise example programs for learning. However, these tools are open-ended and allow a programmer to enter any text as a potential program. This open-ended aspect supports large program development, but is not a sufficient guide for new students of a programming language.

Therefore, a need exists for an interactive animated tool for learning computer programming languages that can concurrently illustrate the program's code, its flow, and its relationships with variables, inputs, and outputs.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

The present invention is a system and method for teaching a computer programming language comprising a visual module, a foundational module, a static module, and a dynamic module.

The visual module further comprises a particular program's example code, a narrator, a console, a variable chart, a variable history, a flowchart, an animation control, a help window, and an optional example-specific control.

The foundational module further comprises a shape module, a script engine, and a ScriptItem.

ScriptItems are stored in a library and are provided to the script engine, which, in turn, calls the shape module. The shape module animates parts of the visual module. This is common across all examples.

The static module provides all of the static data for a given example while the dynamic module provides script items that correspond to the example code.

In animation mode, the user sees an animated representation of the example code's flow. In review mode, the user can click on the visual elements to see the relationship among the parts. The user may move from animation mode to review mode by using a “Fast Forward” feature.

The advantages to the present invention are numerous.

All facets of programming, including programming language, flow, variables, variable history, input, and output, and their inter-relationships, are combined in one interactive, animated learning tool.

Programming concepts are represented graphically by a family of symbols and animations. For example, an active code line, compound statements, a change of variable values, an output to screens, inputs from a keyboard, a change of program flow, true/false conditions, calls to functions, and passing of function or method arguments can be demonstrated through animation, symbols, or color highlighting.

During or after an animation, the user can ask questions of the example by a single mouse click on any part of the screen. Some example questions that can be answered are: “What does this line of code do?”, “Where in the example code was this variable set?”, “What screen output did this line of code produce?”, and “How did this variable's values evolve during the example code's run?”.

While the code animation is running, the corresponding flowchart is animated in tandem, to show the example code's sequence of steps. A sentence or paragraph is also shown above the example code to describe what is happening at that point.

In one embodiment, the present invention is a system including: a processor; an input device for receiving inputs from a user; and a display for displaying a graphical user interface (GUI) including user-actuatable controls responsive to the inputs; wherein the processor causes the GUI to display example programming code, to animate execution of the displayed example programming code, and to control the animation in response to the inputs. The processor implements a plurality of software modules including a visual module, a foundational module, a static module, and a dynamic module. The processor, responsive to the inputs, interacts with a website on a web server to display, animate, and control the example programming code. The processor causes the GUI to highlight a current line of the displayed example programming code. The processor causes the GUI to display a flowchart corresponding to the displayed example programming code, and also causes the GUI to highlight a current step of the displayed flowchart. The processor causes the GUI to display a list of variables associated with the displayed example code, and also causes the GUI to highlight a current variable of the displayed list of variables. The processor causes the GUI to display a console view showing a current output of the displayed example programming code. The processor causes the GUI to display a help window.

In another embodiment, the present invention is embedded as part of an educational system for teaching a programming language, including: a memory for storing predetermined software; a processor for executing the predetermined software to implement a plurality of modules including a visual module, a foundational module, a static module, and a dynamic module; an input device for receiving inputs from a user; and a display for displaying a graphical user interface (GUI) corresponding to the visual module and including user-actuatable controls responsive to the inputs; wherein the processor causes the GUI to display example programming code, to animate execution of the displayed example programming code, and to control the animation in response to the inputs. The foundational module includes a shape library, a ScriptItem library, and a script engine. The processor causes the GUI to highlight a current line of the displayed example programming code.

In a further embodiment, the present invention is a method including: receiving inputs from a user using an input device; displaying a graphical user interface (GUI) including user-actuatable controls responsive to the inputs; displaying example programming code in the GUI using a processor; animating execution of the displayed example programming code using the processor; and controlling the animation by the processor in response to the inputs. The method further includes implementing, using the processor, a plurality of software modules including a visual module, a foundational module, a static module, and a dynamic module. The method further includes interacting, using the processor, with a website on a web server to perform the displaying, animating, and controlling of the example programming code. The method further includes highlighting, using the processor, a current line of the displayed example programming code. The method further includes displaying in the GUI, using the processor, a flowchart corresponding to the displayed example programming code. The method further includes highlighting, using the processor, a current step of the displayed flowchart. The method further includes displaying, using the processor, a help window in the GUI.

### BRIEF DESCRIPTION OF DRAWINGS

The foregoing summary, as well as the following detailed description of presently preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a diagram of an embodiment of the present invention.

FIG. 2 is a screenshot of an initial frame of an animated example of an embodiment of the present invention.

FIG. 3 is a screenshot of a second frame of the animated example of FIG. 2.

FIG. 4 is a screenshot of a third frame of the animated example of FIG. 2.

FIG. 5 is a screenshot of a fourth frame of the animated example of FIG. 2.

FIG. 6 is a screenshot of a fifth frame of the animated example of FIG. 2.

FIG. 7 is a screenshot of a sixth frame of the animated example of FIG. 2.

FIG. 8 is a screenshot of a final frame of the animated example of FIG. 2.

FIG. 9 is a diagram of potential relationships of an example code's components in review mode.

FIG. 10 is a screenshot of the completed animation example of FIG. 2 after the user has clicked on a first code statement.

FIG. 11 is a screenshot of the completed animation example of FIG. 2 after the user has clicked on a second code statement.

FIG. 12 is a screenshot of the completed animation example of FIG. 2 after the user has clicked on a first flowchart shape.

FIG. 13 is a screenshot of the completed animation example of FIG. 2 after the user has clicked on a second flowchart shape.

FIG. 14 is a screenshot of the completed animation example of FIG. 2 after the user has clicked on a variable in the variable section.

FIG. 15 is a schematic of the system of the present invention.

To facilitate an understanding of the invention, identical reference numerals have been used, when appropriate, to designate the same or similar elements that are common to the figures. Further, unless stated otherwise, the features shown in the figures are not drawn to scale, but are shown for illustrative purposes only.

### DETAILED DESCRIPTION

Certain terminology is used in the following description for convenience only and is not limiting. The article “a” is intended to include one or more items, and where only one item is intended the term “one” or similar language is used. Additionally, to assist in the description of the present invention, words such as top, bottom, side, upper, lower, front, rear, inner, outer, right and left may be used to describe the accompanying figures. The terminology includes the words above specifically mentioned, derivatives thereof, and words of similar import.

The core of the approach is to provide an animated simulation of a running example code to show both the sequence of steps the example code takes as well as the inter-relationship of its parts.

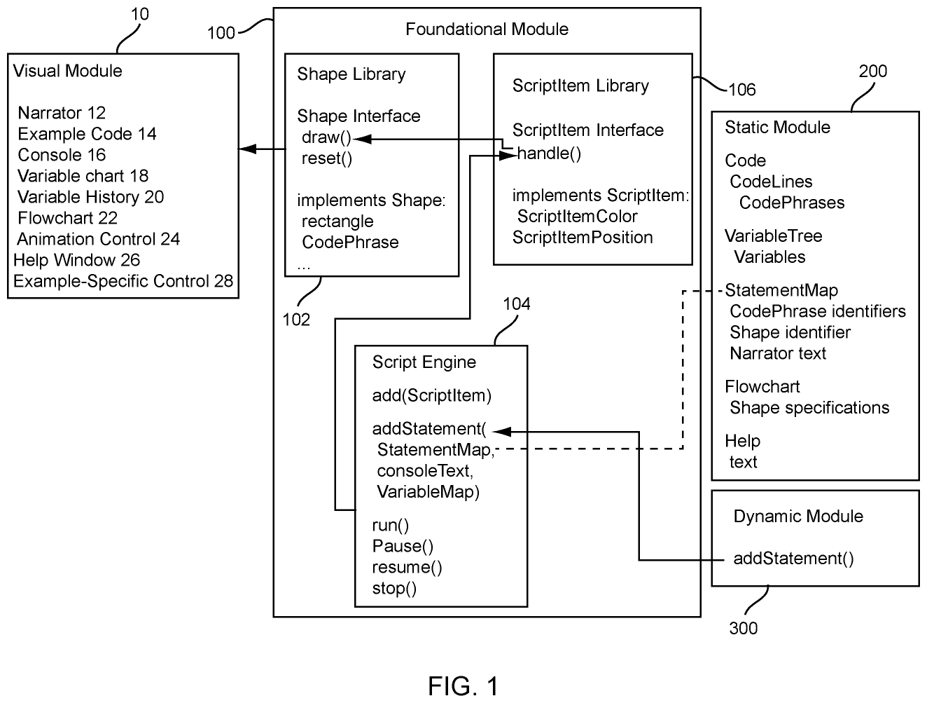

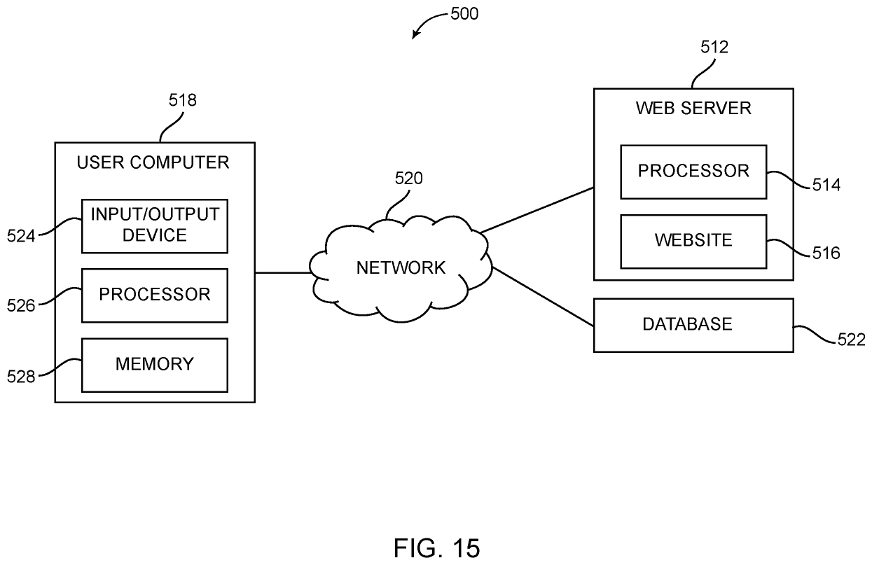

Referring to FIGS. 1 and 15, the present invention is a system 500 and method for teaching a computer programming language. The system 500 includes a server 512, which may be a web server, and which includes a processor 514 and a website 516 with which a user interacts using a user computer 518 communicating with the server 512 through a network 520. The system 500 optionally has a database 522 for storing data and software used by the server 512 to perform the method for teaching a computer programming language.

The user computer 518 includes an input/output (I/O) device 524, a processor 526, and a memory 528, allowing the user to operate software for learning the computer programming language using the system 500 and method described herein. The I/O device 524 may be a keyboard, a mouse, and a display for displaying a graphical user interface (GUI) to operate the software and to interact with the website 516. The user computer 518 may be a personal computer (PC), a mobile device, a smart phone, a laptop, a tablet, or any known computing device for interacting with the website 516. The software may be dynamically loaded into a web browser operated by the processor 526 for interacting with the website 516 on the server 512, or the software may be a stand-alone application for interacting with the server 512. Example web browsers are CHROME™, FIREFOX™, SAFARI™, and INTERNET EXPLORER™.

The processor 526 may be any known microprocessor for executing the software and for executing an operating system, such as WINDOWS™, macOS™, iOS™, and ANDROID™, which is used for interacting with the software through the GUI and through the web browser. The software for learning the computer programming language uses standard web languages such as HTML, XML, cascading style sheets (CSS), JavaScript, scalable vector graphics (SVG), and any other known computing languages and communication protocols for operating with the website 516 and the GUI of the user computer 518 for processing user inputs and interactions. Common files in HTML, CSS, or JavaScript are used for any code example, and example-specific files in XML or JavaScript are used for a specific code example. Such common and example-specific files are stored, such as on the disk of the web server 512 and/or in the database 522.

In use, in a first embodiment, the system 500 and method begin with a user entering a web address of a predetermined table of contents of computer programming languages and lessons, by entering a URL in the web browser displayed in the GUI of the user computer 518, which is in turn received at the website 516 for processing of the URL. Alternatively, each specific example code capable of animation can be presented within a specific educational platform, such as within an iframe which in turn is within an application. In this alternative embodiment, the user computer 518 is a client as an iframe of the application, as opposed to being a client running a web browser.

In the first embodiment, the input of the URL serves as a request which is routed to the web server 512 which hosts the files for teaching a computer programming language. The web server 512 then returns and sends to the user computer 518, for display in a web browser, an HTML page which lists the table of contents of the available computer programming languages and lessons.

The user then selects an example code of interest from the table of contents, with the example code of interest capable of being animated as described herein. The user selection generates a specific example identifier as a selection parameter which serves as a request from the web browser of the user to the web server 512 for standard HTML and/or CSS files for the computer programming language code or lessons corresponding to the specific example identifier. In addition, the web browser of the user requests all example-specific XML files and JavaScript files from the web server 512 and/or the database 522, with such files covering the layout of the software, any help text, an animation script, and examples-specific choice lists. The web server 512 and/or the database 522 responds to the user request by returning or sending the example-specific XML files and JavaScript files to the web browser. The browser with the example-specific files is then ready for user interaction with the selected example, so that all subsequent interaction for the selected example is performed within the browser, and no further requests for data from the web server 512 are made. Alternatively, the browser at the user computer 518 may communicate continually or at stages with the web server 512 to download, to the browser of the user computer 518, any additional files for implementing the selected example of a computer programming language or lesson.

As shown in FIG. 1, the system 500 also comprises a visual module 10, a foundational module 100, a static module 200, and a dynamic module 300, with which a user interacts through a user computer 518 using the I/O device 524 and/or the GUI of the user computer 518 after the user computer 518 and/or the web browser receives the example-specific files for teaching the user the selected computer programming language or lesson.

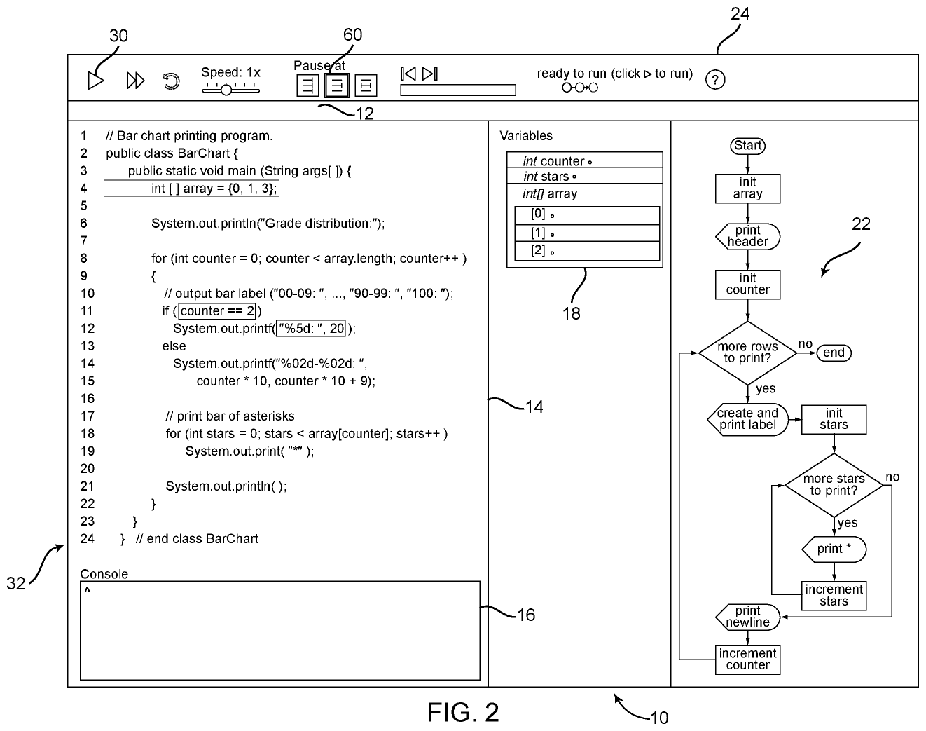

The visual module 10 further comprises a narrator 12, an example code 14, a console 16, a variable chart 18, a variable history 20, a flowchart 22, an animation control 24, a help window 26, and an optional example-specific variation control 28, which are shown in greater detail in FIGS. 2-14. The visual module 10 is displayed in the GUI and/or in the web browser at the user computer 518.

Referring to FIGS. 2-8, in its simplest usage, the user selects an example code 14 of interest and chooses the green triangle 30 (“play” symbol) from the animation control 24 to see an animation of the example code 14 running. During this animation, visual animated cues show what is happening in the example code 14 at that point.

The example code 14 that is under review by the user is displayed on the screen of the display of the user computer 518; for example, in the GUI and/or the web browser. The example code 14 is typically one or more lines of program code. The code may be in any procedural programming language including, but not limited to, Java, JavaScript, C++, C, and Python. Part of the animation is related to subsets of the example code 14 being highlighted at any one time. A specific listing of example code 14 is shown in FIGS. 2-8 and 10-14, which was obtained from the book Java How To Program, Late Objects (11th Edition), PEARSON EDUCATION, INC., Hoboken, N.J. (2018).

The example code 14 is displayed as a code statement and an associated a line number. A code statement is a primary executing element of a running program, which corresponds to certain text in an example code. The code statement is a set of one or more code phrases. A code phrase is an atomic sequence of characters that may be highlighted. A code line is a line of code comprising one or more code phrases. A code statement may also be composed of expressions. An expression can also be represented as a code phrase. The reason for this arrangement is that a line of code is not always the unit of learning. In general, a code statement is the main unit of learning, which can span multiple lines. Conversely, a line of code may contain several code statements.

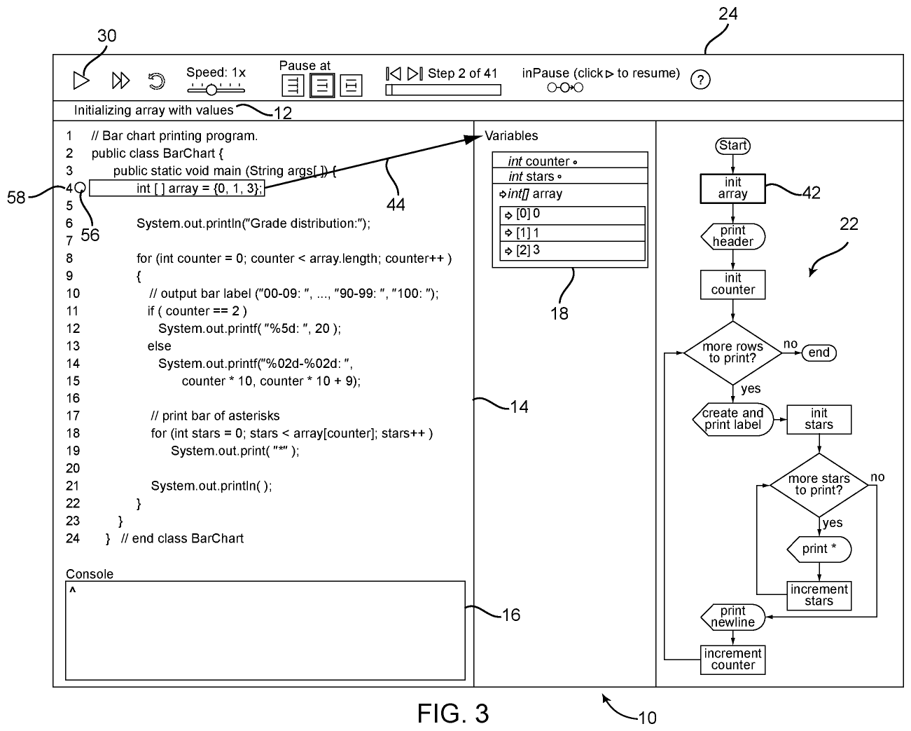

Next to each line of code is a line number 32, from 1 to n, where n is the number of lines in the example code 14. The currently executing statement is shown by color highlighting, e.g., in yellow such as the highlighted text 34 in FIG. 3.

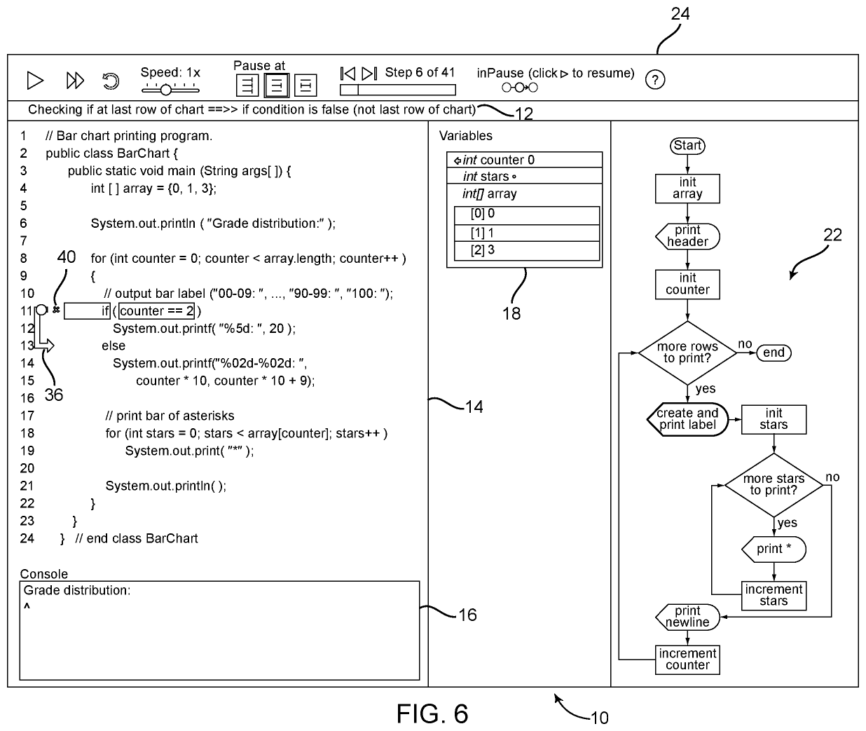

In the exemplar embodiment, a yellow highlight indicates the currently running example code statement. A “turn signal” 36 (green arrow), as shown in FIG. 6, indicates that the example code flow is jumping to a non-sequential example code statement such as a previous statement in a loop or a non-sequential subsequent statement due to a conditional flow of control.

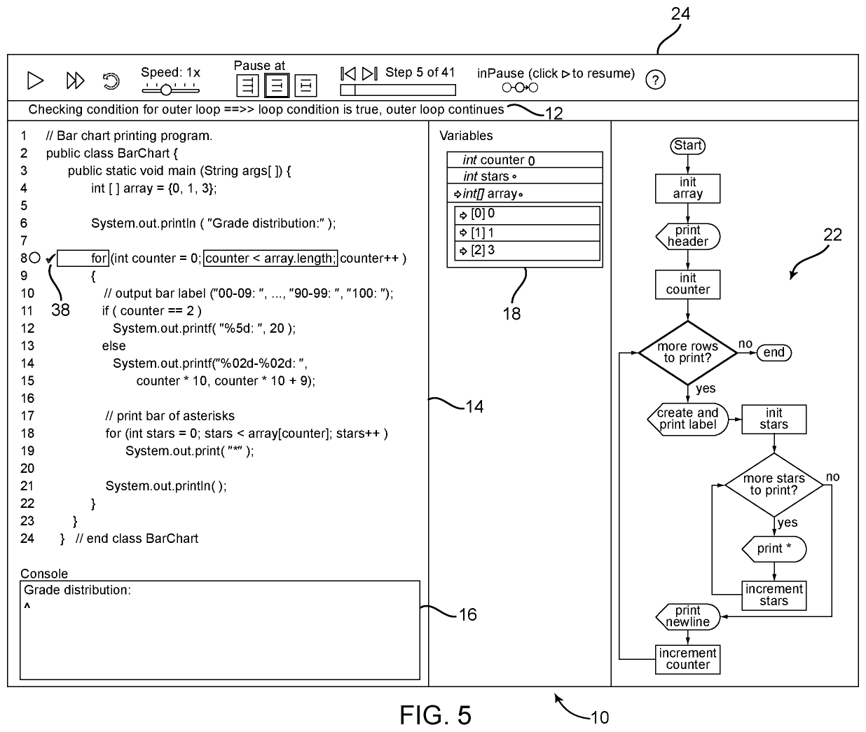

A “stop” or “go” symbol, i.e., an “X” 38 in FIG. 6, or a checkmark 40 in FIG. 5, indicates whether an example code expression in a statement is true or false.

A “passing lane” symbol indicates a value flowing from one example code module to another. The arrow connects the caller's argument to the called function or method's argument.

A “points of interest” symbol, i.e., an oval outline, around an example code fragment indicates key aspects of the example code 14.

The narrator 12 is a section on the screen that describes, in words, what is currently happening in the simulated example code 14. The description may be a phrase, sentence, or paragraph. For example, if the active example code is “x=1;” the narrator 12 may state, “The variable x is being set to the value 1.” As shown in the example in FIG. 3, the narrator 12 states “Initializing array with values”.

Most basic programming examples involve displaying text on the screen, typically in a “console” window, or receiving input from a user typing on a keyboard, also displayed in the console window. The present invention simulates both of these examples by providing a console 16 where outputs and inputs are shown. The current statement's output or input is highlighted in the console 16 to show what is happening in the current step of the example code 14. The outputs and inputs are distinguished by different colors, though in an actual running of the example code 14, no color difference may exist.

The variable in the variable chart 18 and its value are based on the standard programmatic variable lifecycle, e.g., pre-birth, born, alive/set, alive/get, and out-of-scope.

A pre-birth variable is not active and is not shown, or it may be shown in a dim color such as grey. A born variable is created by a statement and is highlighted in green. An alive/set variable has its value set by a statement and its value is highlighted in yellow. An alive/get variable is a variable whose value is referenced but not set by a statement and is highlighted in blue. An out-of-scope, or retired, variable is no longer alive, and its value is shown as dimmed in a dim color such as grey.

The organization of variables is a significant aspect of programs and is represented as a hierarchy in the variable chart 18. This hierarchy allows composite variables, including arrays, structures, and objects, to be represented. The hierarchy also allows the displaying of variables according to an overall structure that some programs have, i.e., functions, modules, classes, etc. The approach is to have one hierarchical tree that unifies the display of all variables and their values of the example code 14.

A variable's value change is a significant event in a program's sequence. The tool may optionally use a scroll technique, or an odometer, to move out and dim the prior value and/or move in and make visible the new value. This allows the prior and present variable values to be seen and compared at the same time. The outgoing value is scrolled off its location on the screen and gradually dimmed and the incoming value is concurrently scrolled into place.

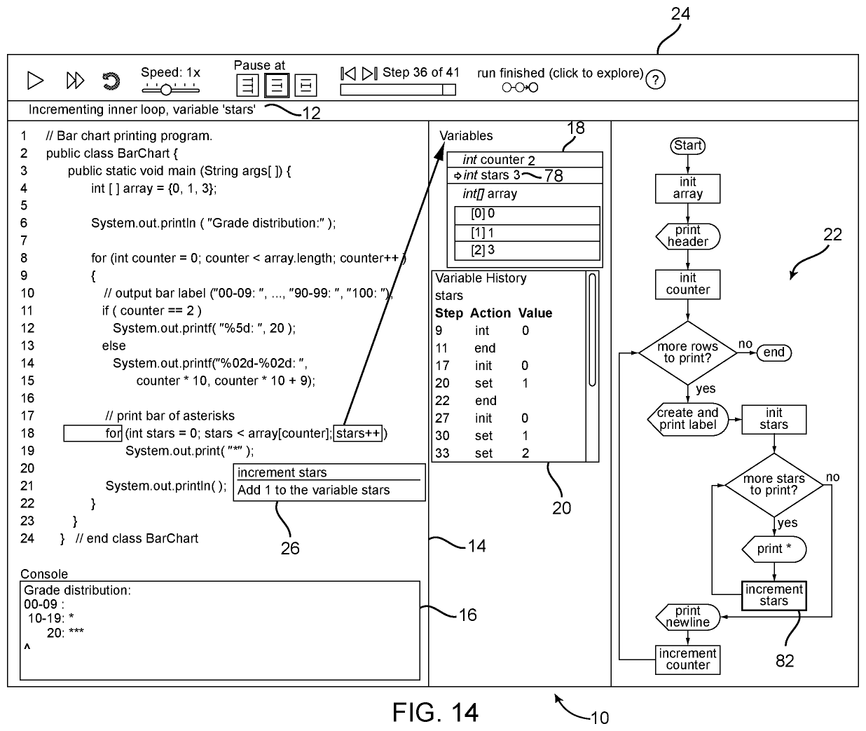

As the variable chart 18 shows the current values for an example code 14 at a point in time, the history of variables' values is shown through a companion variable history 20, such as shown in FIG. 14. In this section of the screen, each variable's name and then-current value is shown. From this section, the sequence of changes of variable values can be reviewed.

Flowcharts have long been a standard visual representation of a sequence of states for a program's logic. The animated flowchart 22 is a new technique to highlight, in parallel with the example code's current statement, which step in the flowchart 22 is current. This is achieved by highlighting a shape representing discrete example code's steps or an arrow connecting shapes representing a transition between states in a given frame of the animation. In this way, a flowchart animation concurrently shows the sequence of steps that the example code 14 is taking. Flowchart shapes and arrows can be taken from standard conventions or from an alternative design.

The flowchart shapes can be mapped statically through the static module 200. In particular, a StatementMap argument would include a code statement identifier and a flowchart shape identifier. The StatementMap may also contain other elements such as narrator text or a flowchart arrow identifier. The StatementMap identifier is passed to the addStatement( ) method of the script engine 104. The script engine 104 then creates script items which are passed to the add( ) method for rendering as visual elements.

A flowchart shape may map to one statement or to multiple statements. For the latter case, an example flowchart step 42, shown in FIG. 3, may be “Initialize variables” but this may involve multiple example code statements. The flowchart shape can indicate this one-to-many relationship with a bold outline of its shape.

The animation can be started, stopped, paused, resumed, or fast-forwarded, and the speed of the animation can be adjusted through the animation controls 24.

In the prior art, a specific program example in a book is fixed and unalterable for a specific code. However, in the present invention, the system 500 and method allow variations of example code 14, by providing the user with pre-determined alternatives to choose from in the optional example-specific control 28 of the visual module 10. For example, if an example code calculates the odds of winning a lottery, whereas a fixed example in a book in the prior art might set the count of numbers drawn for the lottery (e.g., 6), the system 500 and method present invention can allow the user to select from a set of alternatives (e.g., 4, 5, or 6). In this way, the user can review alternative flow and calculation variations of the example code 14.

In some cases, it is appropriate for the user to make these code variation choices as refinements to the example code 14, such as by a single change. In other cases, it may be appropriate to combine code variation changes into a single user choice that instead control several example code changes at once. For example, the user may choose to run a “small” or “large” example, in which case the example code 14 will be revised and run using those settings.

As shown in FIG. 1, the internal organization of the system 500 of the present invention comprises a foundational module 100, a static module 200, and a dynamic module 300.

The approach that the present invention borrows for its animation is a commonly used pattern for animating shapes on a computer screen, e.g., a collection of shapes with associated code to draw each shape; a way to change any shape's properties during the animation; and a presentation of a sequence of frames that give the appearance of an animation. By varying the shapes' properties (e.g., location, color, etc.) between frames, an animated sequence is displayed. In the case of the present invention, the animation is tailored to show specific programming coding concepts.

The foundational module 100 further comprises a shape module 102, a script engine 104, and ScriptItem library 106.

The shape module 102 animates the elements of the visual module 10. The shape module 102 includes a draw( ) method and a reset( ) method.

The draw( ) method displays the shape based on the shape's current properties. By initially calling this method for all shapes, the tool displays an initial example. By subsequently calling this method for certain shapes, the visual elements are animated.

The reset( ) method is called at the beginning of a new animation to set the shapes to their initial states.

Specific shapes that implement the shape module 102 can have any properties they need, i.e., there are no specific properties required of the shapes. However, most shapes will have at least these properties: location (e.g., x and y coordinates), size (e.g., height and width), and whether they are currently visible. Example shapes include a flowchart rectangle shape and a code shape.

The flowchart rectangle shape is a low-level example of a shape. It is used to draw a rectangle on the screen, for example, as part of a flowchart 22. Its properties include location (x, y), size (height, width), text to place inside the shape, if any, and background color. For example, to be used in an animated sequence, the color may be changed to highlight that this shape is current in the simulation.

The code shape is an example of a high-level shape. It contains both the specific text of the example code 14 as well as several other shapes (e.g., highlights, arrows) that in combination can animate the activities of the example code 14.

The script engine 104 is the controller for updating and presenting each frame of the animation. The approach here is to queue up a sequence of script items in the ScriptItem library 106, in order to adjust shapes to show an animated sequence. The script engine 104 includes an add( ) method, an addStatement( ) method, a run( ) method, a pause( ) method, a resume( ) method, and a stop( ) method.

The add( ) method adds a script item to the animation script queue. The addStatement( ) method adds a set of script items in the ScriptItem library 106 that corresponds to animating an example code statement. The run( ) method displays the animation sequence frames. The pause( ) method pauses the animation sequence that is currently running at the current frame. The resume( ) method resumes the animation sequence that was previously paused. The stop( ) method prematurely stops the animation sequence.

The ScriptItem interface in the ScriptItem library 106, as implemented by specific types of ScriptItems, is used as the general way to adjust properties of the animation before a frame is displayed. “Single-step” ScriptItems in the ScriptItem library 106 will adjust one or more properties in a single step. “Multi-step” ScriptItems in the ScriptItem library 106 will adjust one or more properties over a sequence of frames, for example, to appear to move a shape across the screen. The ScriptItem library 106 also includes a handle( ) method.

A ScriptItem's handle( ) method is called by the script engine 104 before the next frame is displayed. Its return type is Boolean to indicate if the script item 106 has completed its work or if its handle( ) method should be called again for the next frame. For Single-step ScriptItems in the ScriptItem library 106, handle( ) will always return “true.” For multi-step script items in the ScriptItem library 106, handle( ) will return “true” when the multi-step script items have completed their animation steps. Otherwise, a multi-step ScriptItem's handle( ) will return “false” to indicate this particular ScriptItem has more animation to perform.

The static module 200 and the dynamic module 300 are used to animate specific examples. The static module 200 is a text-based data representation of all of the static aspects of the example code 14. The dynamic module 300 is a programmatic representation that mimics the steps of the example code.

In the exemplar embodiment, the static module 200 and the dynamic module 300 are manually created by the developer, but automated methods could be implemented as well.

The static module 200 is an example-specific representation of all of the static aspects of the example being animated. These are represented in a data file; for example, in XML or in a JSON format. The data file may include the initial location, size, colors, and other properties of shapes, the text of the example code 14, the elements to animate, the relationship of the example code 14 to the flowchart, and the textual help in the help window 26 available for different sections of the example code 14.

The dynamic module 300 is an example-specific representation of all of the dynamic aspects of the example code 14 being animated. The dynamic module 300 parallels the logic of the program example 14. Its implementation can be in another language from the example code 14. For example, in an Internet browser implementation, the dynamic module 300 can be implemented in JavaScript, even though the example code 14 may be in another language such as C++. This translation of one example code to another can be done manually or it may be automated.

The primary role of the dynamic module 300 is to create a queue of script items 106 that control the elements of the animation. At the lowest level, this involves successive calls to the script engine's add( ) method. Higher-level calls to the script engine's addStatement( ) method, can be used to simplify and standardize the domain-related animation steps.

In each of FIGS. 2-8, only a single point in time is shown. In practice, the animation will include a sequence of individual steps, for example, a flowchart shape is highlighted, such as the step 42 in FIG. 3, then a line in the example code 14 is highlighted, such as the line 34 in FIG. 3, then an arrow is drawn from the example code phrase to the variable chart 18, such as the arrow 44 in FIG. 3, then the variables that are created are revealed and shown in red.

FIG. 2 shows the initial view before the animation starts. No elements are highlighted. The user can begin the animation by clicking on the “Play” symbol 30 in the upper left of the screen 10.

After the user hits the green triangle 30 (the “play” symbol), the screen of FIG. 3 is shown. The first example code statement 34 is highlighted in yellow and shows the created variable's name, and its value highlighted in green, as shown in the variable chart 18 in FIG. 3. The corresponding step 42 in the flowchart 22 is also highlighted in yellow.

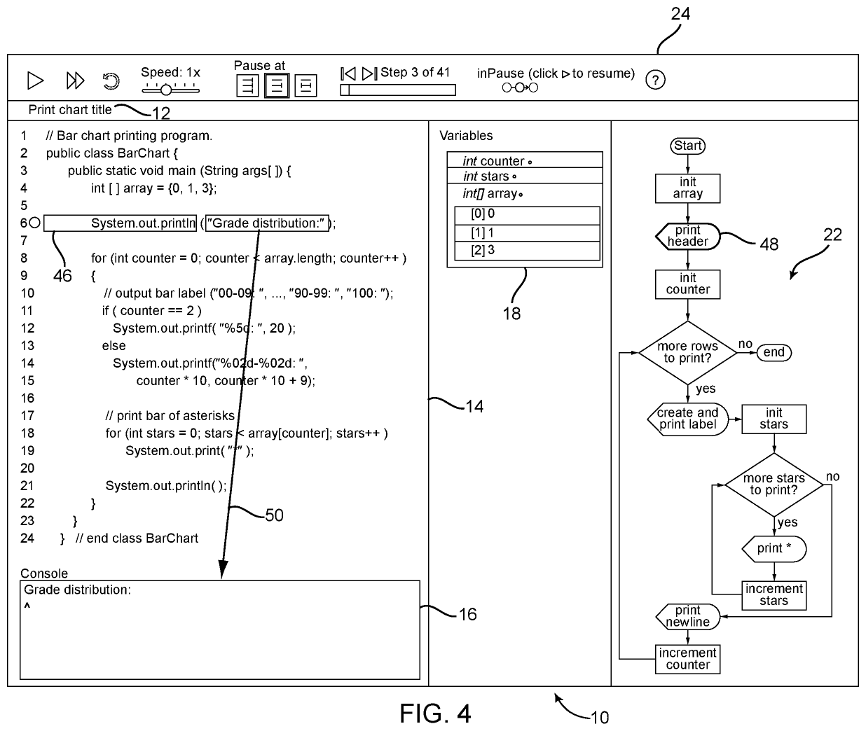

In FIG. 4, the second example code statement 46 is highlighted, as well as the corresponding step 48 in the flowchart 22. This example code statement generates an output to the console, which is shown in the console 16 at the bottom of the screen in FIG. 4. An arrow 50 from the code to the black box indicates that this statement has generated some output.

In FIG. 5, the green checkmark 38 in the example code 14 indicates that the statement expression (counter<array.length) is true. As a result, for this example, the example code flow will continue to the next statement. The highlighted code is part of a line, in this case the active phrase of a “for statement,” since a “for statement” is made up of multiple sub-statements.

In FIG. 6, the red X mark 40 on the left in the example code 14 indicates that the expression (count==2) is false. In this example, the example code 14 will then skip the next line and continue at the “else” statement. The line skip is indicated by the green arrow 36 (turn signal) at the left in the example code 14.

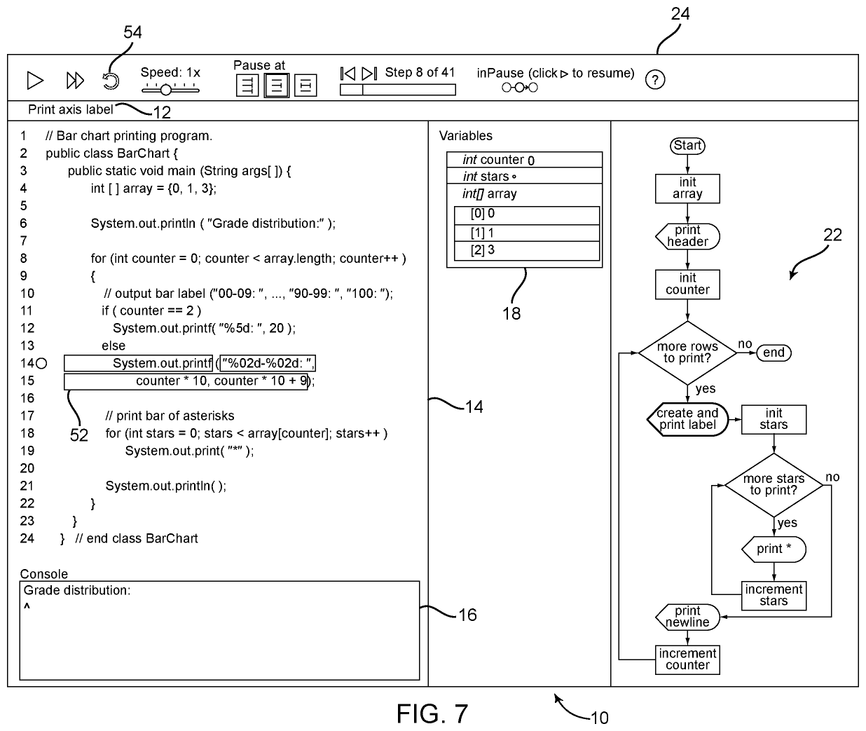

In FIG. 7, the active code statement 52 spans two lines and is highlighted as such. The example code statement 52 is also colored in two parts. The orange highlighting indicates the primary part of the code statement. The yellow highlighting indicates the secondary part of the code statement, i.e., the argument of the first part of the statement. A “Reset” or “Replay” button 54 is displayed in FIGS. 2-7, but the function of the button 54 is not available since the button 54 is not highlighted in red.

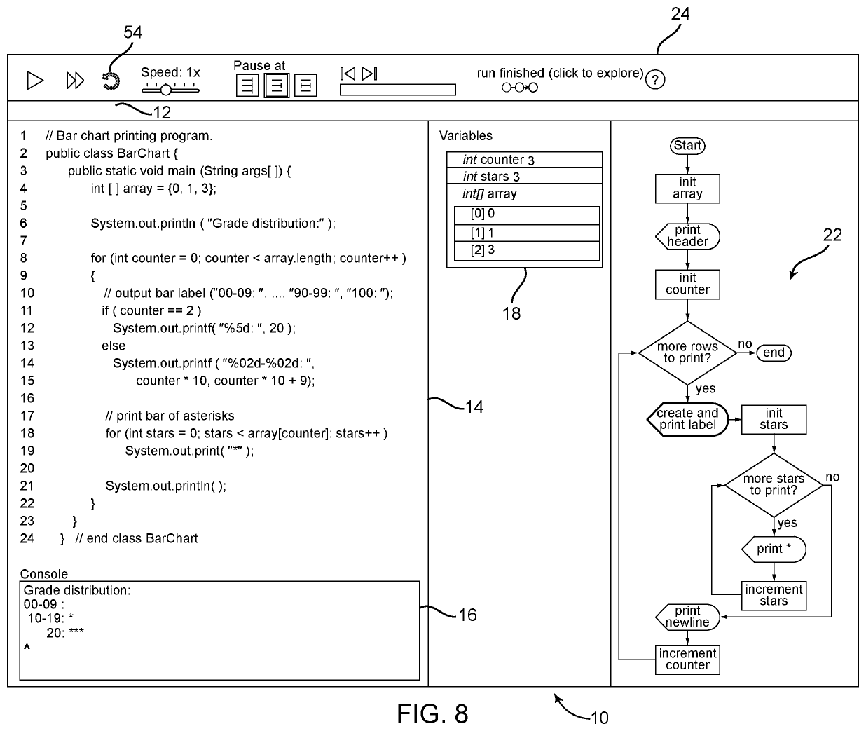

FIG. 8 shows the end of the animation, at which point no elements are highlighted. The status indicator 24 in the upper middle indicates “run finished”. The “Reset” or “Replay” button 54 is available and highlighted in red, allowing the user to restart the animation from the beginning of the example code 14.

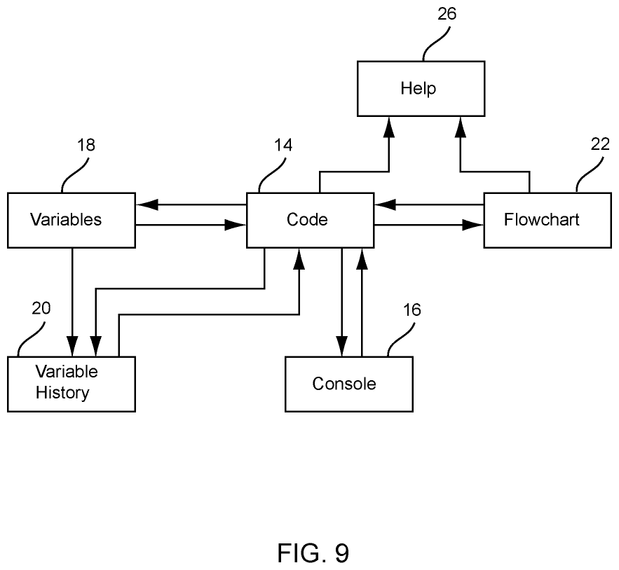

FIG. 9 shows an example of possible relationships between the elements of the visual module 10, specifically, between the example code 14, the variable chart 18, the variable history 20, the console 16, and the flowchart 22.

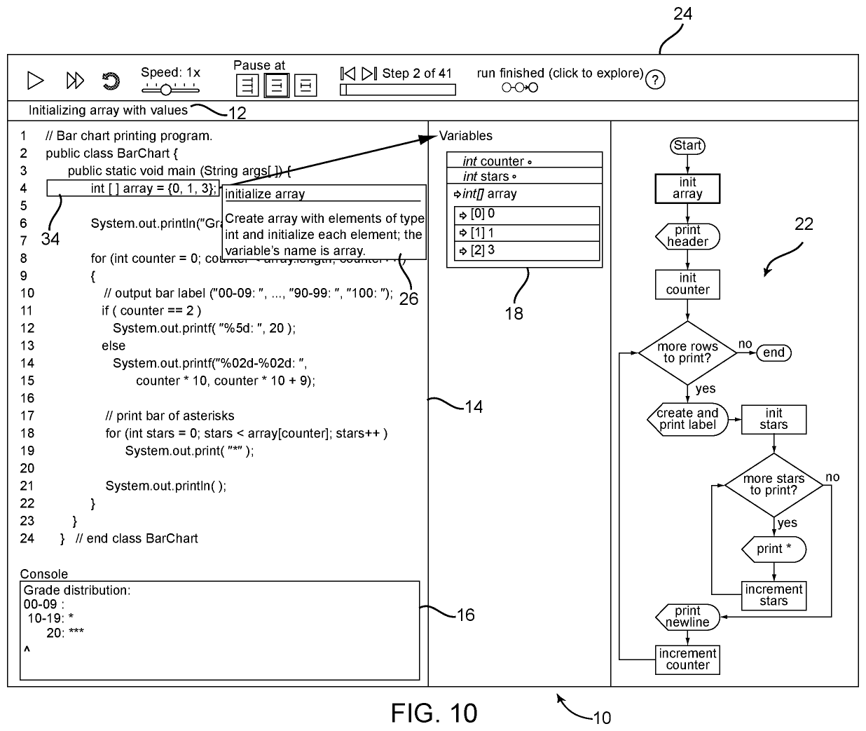

Referring to FIGS. 10-14, after an example code 14 has finished its run or after it is paused, the user uses the controls 24 so that the example code 14 is in review mode. The user can learn about the example code's relationships among its parts; e.g., by mouse clicking on different sections of the screen 10. Highlighting shows all related aspects of the example code 14 and its variables, input/output text, and flowchart shapes. In addition, the help window 26 may appear which will display a description about that code statement, flowchart shape, or variable.

At any point during or after an animation, the user can discover static and dynamic relationships. Static relationships are those relationships known before the animation is run, for example, the relationship between a code statement and a flowchart shape. Dynamic relationships are recorded in memory as part of the animation. For example, the relationship between a code statement and a variable, or between a code statement and a console output, are dynamic relationships.

The recorded animation steps allow the user to review earlier steps or resume the animation at an earlier step without having to restart the animation from the beginning.

By clicking on an item in one element, other items in other elements are automatically highlighted according to the relationship. For example, as shown in FIG. 10, clicking on a code statement in the example code 14 may highlight a description of the code statement in the help window 26, the updated variable in the variable chart 18, the updated variable in the variable history 20, the output in the console 16, and the corresponding step in the flowchart 22.

Clicking on a variable in the variable chart 18 may highlight the example code statement in the example code 14 that last updated the variable and highlight all instances of the variable in the variable history 20, as shown in FIG. 14.

Clicking on a line in the variable history 20 may highlight the example code statement in the example code 14 that created or updated the variable at that point in in the history.

Clicking on a line in the console 16 may highlight the code statement in the example code 14 that outputted the line or, in the case of inputs, the code statement in the example code 14 that received the input.

Clicking on a step in the flowchart 22 may highlight the example code statement in the example code 14 corresponding to that step, and provide a description of the step in the help window 26, as shown in FIGS. 10-14.

In addition to seeing an example code animation run uninterrupted, the user can preemptively set points, i.e., “rest stops,” in the example code 14 where the animation will pause. For example, in FIG. 3, a red circle 56 may be set by the user as a rest stop by clicking the line number 58 in the example code 14. This gives the user the ability to see variable and console states before the code statement executes, as well as to see what has just happened due to a code statement execution.

The mechanics for rest stops are similar to “breakpoints” in most Integrated Development Environments. Clicking on a line number will toggle a rest stop for statements that begin on that line. However, unlike IDEs, using the system 500 in the present invention, the animation may pause at a rest stop both before and after the statement is animated. These pause points are referred to respectively as pre-paused and post-paused points.

When the animation pauses at a rest stop 56, the animation will wait to proceed until the user selects the “Play” button 30. When pre-paused, the statement that is about to be animated is highlighted. At post-pause, the statement animation is complete and the cumulative animation symbols are frozen, allowing the user to see the activities that have occurred; such as specific variable updates and read/writes to the console 16.

Similar to rest stops, at any time during an animation, the user can select the “Pause” button 60, as shown, for example, in FIG. 2, to freeze the animation at the current state. This allows review of the example code 14 next to the current animation symbols or by clicking on items to generate help windows 26. To continue the animation the user can select the “Play” button 30. In an alternative embodiment, clicking on any visual element also pauses the animation to allow for review of the state of the example code 14 at the point of time of the pause.

In FIG. 10, the animation has run to completion. The user has now clicked on the code statement 34 in the upper left highlighted in yellow. The related variables that were created by this statement are also highlighted in green in the variable chart 18. The step 42 in the program's flowchart 22 is also highlighted. The help window 26 is displayed on the screen and includes text to describe more about this step 42 in the example code 14.

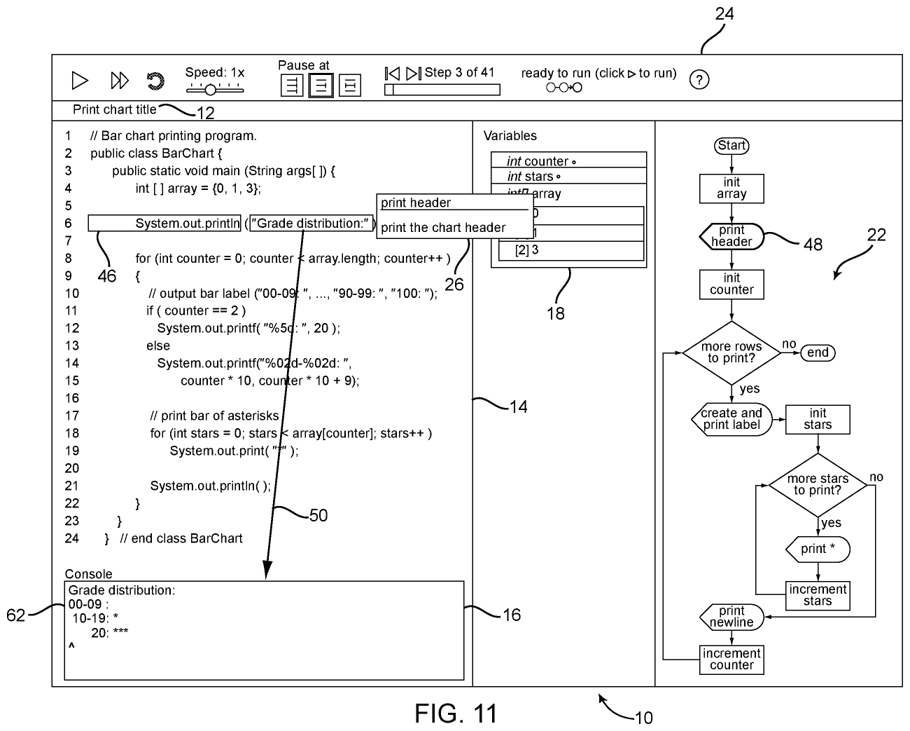

In FIG. 11, the user has clicked on a line 46 in the example code 14 highlighted in yellow. This line 46 had previously generated some output during the animation, which is indicated by the grey highlighted phrase 62 in the console 16. The corresponding step 48 in the flowchart 22 is highlighted and the help window 26 is displayed as well. Alternatively, the user has clicked on a phrase “Grade distribution:” in the console 16, which is then highlighted in grey, and the related code 46 in the example code 14 is highlighted in yellow to show what code phrases or statements generated this output, as well as the related step 48 in the flowchart 22.

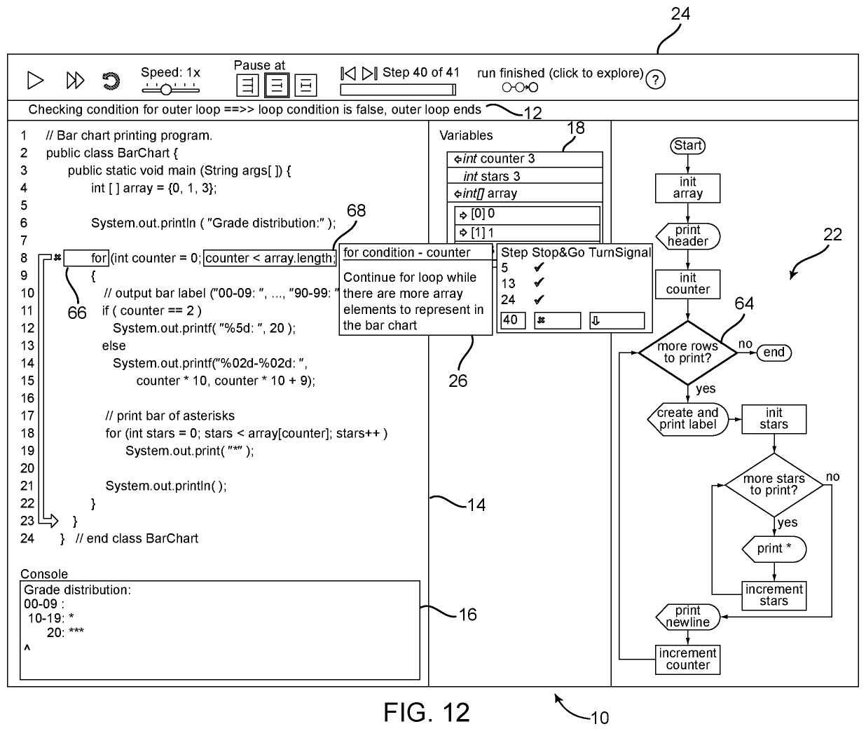

In FIG. 12, the user has selected a shape 64 in the flowchart 22. This flowchart step 64 corresponds to two phrases 66, 68 in the example code 14, so these phrases 66, 68 are highlighted in yellow. The help window 26 describing this step 64 is shown as well.

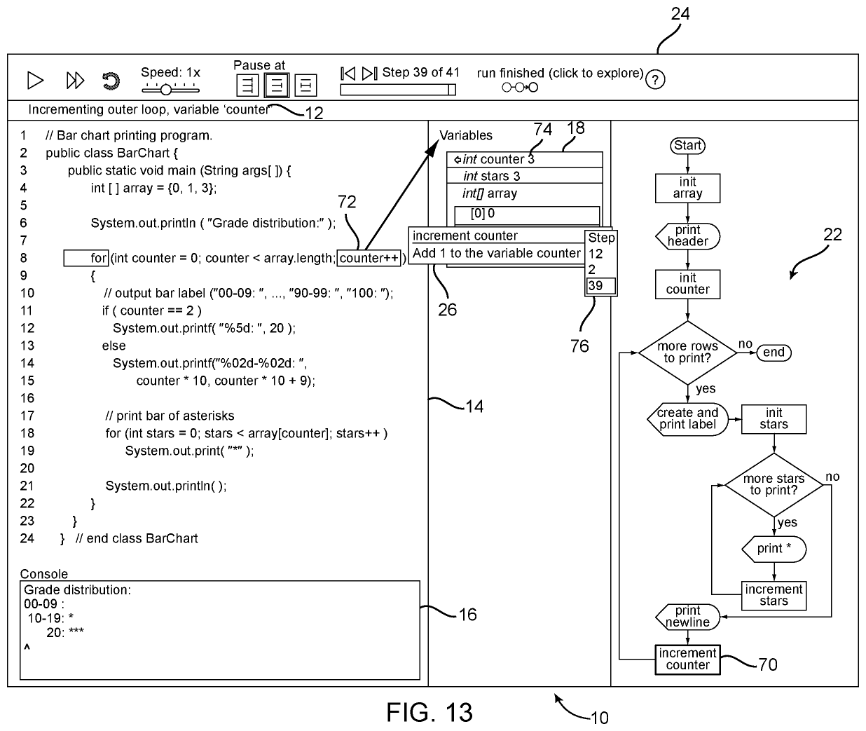

In FIG. 13, the user has selected a shape 70 in the flowchart 22, which is highlighted in yellow. Related aspects are highlighted as well, including the related code 72 in the example code 14 and the corresponding variable value update 74, 76 in the variable chart 18. The help window 26 describing this step 70 is shown as well.

In FIG. 14, the user has clicked in the variable chart 18, on the number “3”, i.e., the value 78 of the “stars” variable. The system 500 highlights the code statement 80 in the example code 14 that last set the value of this variable, as well as the corresponding step 82 in the flowchart 22.

For some example programs, it may be useful to provide some variation in the example code or its inputs to illustrate different program paths. There are three options for providing these variations: direct changes, indirect changes, and program inputs.

For direct changes, the system 500 and method of the present invention can provide alternative code fragments for selection by a list of choices. For example, the user might select a variable to be initially set to 0, 1, or 2, to see how the code runs differently in these cases.

For example code inputs, the system 500 and method of the present invention can allow the user to select from a list of choices, or the tool can choose its own, potentially random, inputs. Both alternatives allow any code animation to proceed without seeking further user input during the animation.

The present invention can be extended in various ways.

In addition to keyboard input and screen output, the system 500 and method of the present invention can be configured to show animated simulations of receiving data in other ways, for example, from files, databases, or networks. Animated representations of these cases are possible extensions.

In the system 500 and method of the present invention, objects are represented as a hierarchy of data. In other embodiments, certain objects can benefit from a more customized representation, e.g., dates, collections, etc. In some cases, this may be simple string representations, e.g., for date type variables. In other cases, they may be more graphical representations, e.g., for collection objects.

In an exemplar embodiment of the present invention, the system 500 and method generates a complete example script before beginning the animation display. In an alternative embodiment, animation steps are alternatively generated and executed, in order to provide the user more interactive capability during the animation.

In the exemplar embodiment, the primary unit of animation is the code statement. In an alternative embodiment, an extension that animates at a lower level (e.g., expressions) would allow a more detailed review of a program's logic, for example, the order in which mathematical expressions is evaluated.

In cases where two programming language examples are sufficiently similar, it may be useful to show side-by-animation of the two language examples. This can be useful when the user is already familiar with one programming language and is learning another.

In the exemplar embodiment, the example code is modelled manually by populating the static and dynamic modules 200, 300 with data and script items 106. In another embodiment, an automation module could automate this process by translating the text of the program example to data and script items in the ScriptItems library 106.

Although the embodiment shown and described herein relates to teaching and learning computer programming, the system 500 and method of the present invention could be applied to other subjects where processes or algorithms can be graphically animated or represented by flowcharts. For example, the present invention could be used to teach academic subjects such as mathematics, physics, chemistry and economics to name a few. As well, the present invention could be used to teach or show the steps, requirements and documents relating to financial transactions, real estate transactions and automobile sales, to name a few.

The present invention may be embodied in other specific forms without departing from its spirit or essential characteristics. The described embodiments are to be considered in all respects only as illustrative and not restrictive. The scope of the invention, therefore, will be indicated by claims rather than by the foregoing description. All changes, which come within the meaning and range of equivalency of the claims, are to be embraced within their scope.

What is claimed is:

1. A system comprising:
a processor;
an input device for receiving inputs from a user; and
a display for displaying a graphical user interface (GUI) including user-actuatable controls responsive to the inputs;
wherein the processor causes the GUI to display example programming code, to animate execution of the displayed example programming code, and to control the animation in response to the inputs.

2. The system of claim 1, wherein the processor implements a plurality of software modules including a visual module, a foundational module, a static module, and a dynamic module.

3. The system of claim 1, wherein the processor, responsive to the inputs, interacts with a website on a web server to display, animate, and control the example programming code.

4. The system of claim 1, wherein the processor causes the GUI to highlight a current line of the displayed example programming code.

5. The system of claim 1, wherein the processor causes the GUI to display a flowchart corresponding to the displayed example programming code.

6. The system of claim 5, wherein the processor causes the GUI to highlight a current step of the displayed flowchart.

7. The system of claim 1, wherein the processor causes the GUI to display a list of variables associated with the displayed example code.

8. The system of claim 7, wherein the processor causes the GUI to highlight a current variable of the displayed list of variables.

9. The system of claim 1, wherein the processor causes the GUI to display a console view showing a current output of the displayed example programming code.

10. The system of claim 1, wherein the processor causes the GUI to display a help window.

11. An educational system for teaching a programming language comprising:
a memory for storing predetermined software;
a processor for executing the predetermined software to implement a plurality of modules including a visual module, a foundational module, a static module, and a dynamic module;
an input device for receiving inputs from a user; and
a display for displaying a graphical user interface (GUI) corresponding to the visual module and including user-actuatable controls responsive to the inputs;
wherein the processor causes the GUI to display example programming code, to animate execution of the displayed example programming code, and to control the animation in response to the inputs.

12. The educational system of claim 11, wherein the foundational module includes a shape library, a ScriptItem library, and a script engine.

13. The educational system of claim 11, wherein the processor causes the GUI to highlight a current line of the displayed example programming code.

14. A method comprising:
receiving inputs from a user using an input device;
displaying a graphical user interface (GUI) including user-actuatable controls responsive to the inputs;
displaying example programming code in the GUI using a processor;
animating execution of the displayed example programming code using the processor; and
controlling the animation by the processor in response to the inputs.

15. The method of claim 14, further comprising:
implementing, using the processor, a plurality of software modules including a visual module, a foundational module, a static module, and a dynamic module.

16. The method of claim 14, further comprising:
interacting, using the processor, with a website on a web server to perform the displaying, animating, and controlling of the example programming code.

17. The method of claim 14, further comprising:
highlighting, using the processor, a current line of the displayed example programming code.

18. The method of claim 14, further comprising:
displaying in the GUI, using the processor, a flowchart corresponding to the displayed example programming code.

19. The method of claim 18, further comprising:
highlighting, using the processor, a current step of the displayed flowchart.

20. The method of claim 14, further comprising:
displaying, using the processor, a help window in the GUI.
